(19) United States
(12) Patent Application Publication
(10) Pub. No.: US 2023/0316107 A1
(43) Pub. Date: Oct. 5, 2023

(54) INFORMATION PROCESSING DEVICE, INFORMATION PROCESSING METHOD, AND RECORDING MEDIUM

(71) Applicant: NEC Corporation, Minato-ku, Tokyo (JP)

(72) Inventors: Yuzuru OKAJIMA, Tokyo (JP); Yoichi SASAKI, Tokyo (JP); Kunihiko SADAMASA, Tokyo (JP)

(73) Assignee: NEC Corporation, Minato-ku, Tokyo (JP)

(21) Appl. No.: 18/022,720

(22) PCT Filed: Aug. 27, 2020
(86) PCT No.: PCT/JP2020/032454

§ 371 Date: Feb. 22, 2023

(51) Int. Cl. G06N 5/025

(52) U.S. Cl. CPC G06N 5/025

(57) ABSTRACT

In an information processing device, an observation data input means receives a pair of observation data and a predicted value of a target model for the observation data. A rule set input means receive a rule set including a plurality of rules, the rule including a pair of a condition and a predicted value corresponding to the condition. A satisfying rule selection means selects a satisfying rule from the rule set, the satisfying rule being a rule in which the condition becomes true for the observation data. An error calculation means calculates an error between a predicted value of the satisfying rule for the observation data and the predicted value of the target model. A surrogate rule determination means associates the rule which minimizes the error, among the satisfying rules, with the observation data as a surrogate rule for the target model.

### TECHNICAL FIELD

The present invention relates to prediction using a machine learning model.

### BACKGROUND ART

In the field of machine learning, rule-based models that combine multiple simple conditions have an advantage of easy interpretation. A typical example is a decision tree. Each node of the decision tree represents a simple condition, and tracing the decision tree from the root to the leaves is equivalent to predicting using a decision rule that combines multiple simple conditions.

On the other hand, machine learning using complex models such as a neural network and ensemble models are showing high prediction performance and attracting attention. While these models can show high prediction performance compared with rule-based models such as decision trees, they have such a disadvantage that the internal structure is complicated and it is difficult for humans to understand the reason of the prediction. Therefore, such a model with low interpretability is called a “black-box model.” In order to address this drawback, it is recommended to output an explanation about the prediction when the model with low interpretability outputs the prediction.

If the method of outputting the explanation depends on the internal structure of a particular black box model, it is not applicable to other models. Therefore, it is desirable that the method of outputting the explanation is model-independent (model-agnostic) method, which is independent of the inner structure of the model and can be applied to any model.

In the above technical field, Non-Patent Document 1 discloses a technique as follows. When a certain example is inputted, a model with low interpretability outputs a prediction for the example. Then, the examples existing in the vicinity of the certain example are regarded as training data and used to train a new model with high interpretability, and the new model is presented as an explanation of the prediction. Using this technique, it is possible to present an explanation of the prediction outputted by the models with low interpretability to humans.

### PRECEDING TECHNICAL REFERENCES

### Patent Document

Non-Patent Document 1: Marco Tulio Ribeiro, Sameer Singh, Carlos Guestrin, “Why Should I Trust You?”: Explaining the Predictions of Any Classifier, Proceedings of the 22nd ACM SIGKDD International Conference on Knowledge Discovery and Data Mining, August 2016, Pages 1135-1144, https://doi.org/10.1145/2939672.2939778

### SUMMARY

### Problem to be Solved by the Invention

In the technique disclosed in Non-Patent Document 1, there is a concern that the outputted explanation becomes difficult for humans to accept. This is because the technique disclosed in Non-Patent Document 1 is only retraining using the examples existing in the vicinity of an inputted example, and it is not guaranteed that the predictions of the two model become close. In this case, the predictions outputted by the highly interpretable models as the explanation may differ significantly from the predictions outputted by the original model. In that case, even if the original model is a model with high accuracy, the model outputted as the explanation would be less accurate, making it difficult for humans to accept the explanation.

One object of the present invention is to present a rule that is easily accepted by humans as an explanation for a prediction outputted by a machine learning model.

### Means for Solving the Problem

According to an example aspect of the present invention, there is provided an information processing device comprising:
an observation data input means configured to receive a pair of observation data and a predicted value of a target model for the observation data;
a rule set input means configured to receive a rule set including a plurality of rules, the rule including a pair of a condition and a predicted value corresponding to the condition;
a satisfying rule selection means configured to select a satisfying rule from the rule set, the satisfying rule being a rule in which the condition becomes true for the observation data;
an error calculation means configured to calculate an error between a predicted value of the satisfying rule for the observation data and the predicted value of the target model; and
a surrogate rule determination means configured to associate the rule which minimizes the error, among the satisfying rules, with the observation data as a surrogate rule for the target model.

According to another example aspect of the present invention, there is provided an information processing method comprising:
receiving a pair of observation data and a predicted value of a target model for the observation data;
receiving a rule set including a plurality of rules, the rule including a pair of a condition and a predicted value corresponding to the condition;
selecting a satisfying rule from the rule set, the satisfying rule being a rule in which the condition becomes true for the observation data;
calculating an error between a predicted value of the satisfying rule for the observation data and the predicted value of the target model; and
associating the rule which minimizes the error, among the satisfying rules, with the observation data as a surrogate rule for the target model.

According to another example aspect of the present invention, there is provided a recording medium recording a program, the program causing a computer to execute an information processing method comprising:
receiving a pair of observation data and a predicted value of a target model for the observation data;
receiving a rule set including a plurality of rules, the rule including a pair of a condition and a predicted value corresponding to the condition;
selecting a satisfying rule from the rule set, the satisfying rule being a rule in which the condition becomes true for the observation data;
calculating an error between a predicted value of the satisfying rule for the observation data and the predicted value of the target model; and
associating the rule which minimizes the error, among the satisfying rules, with the observation data as a surrogate rule for the target model.

### BRIEF DESCRIPTION OF THE DRAWINGS

FIG. 1 is a diagram conceptually explaining a technique of the present example embodiment.

FIG. 2 shows an example of creating an original rule set using Random Forest.

FIG. 3 is a block diagram showing a hardware configuration of an information processing device according to the first example embodiment.

FIG. 4 is a block diagram showing a functional configuration of the information processing device at the time of training.

FIG. 5 is a diagram showing a processing example of the information processing device at the time of training.

FIG. 6 is a flowchart of processing by the information processing device at the time of training.

FIG. 7 is a block diagram showing a configuration of the information processing device at the time of actual operation.

FIG. 8 is a flowchart of processing by the information processing device at the time of actual operation.

FIGS. 9A and 9B show an example of a black box model and an original rule set.

FIG. 10 shows an example of selecting three surrogate rule candidates.

FIG. 11 shows an error matrix for each rule shown in FIG. 9.

FIG. 12 shows an assignment table of the surrogate rules for each observation data.

FIGS. 13A and 13B show examples of training data and original rule sets.

FIG. 14 shows an example of an assignment table determined by continuous optimization.

FIG. 15 is a block diagram showing a functional configuration of the information processing device of a third example embodiment.

FIG. 16 is a flowchart of processing by the information processing device of the third example embodiment.

### EXAMPLE EMBODIMENTS

### First Example Embodiment

[Basic Concept]

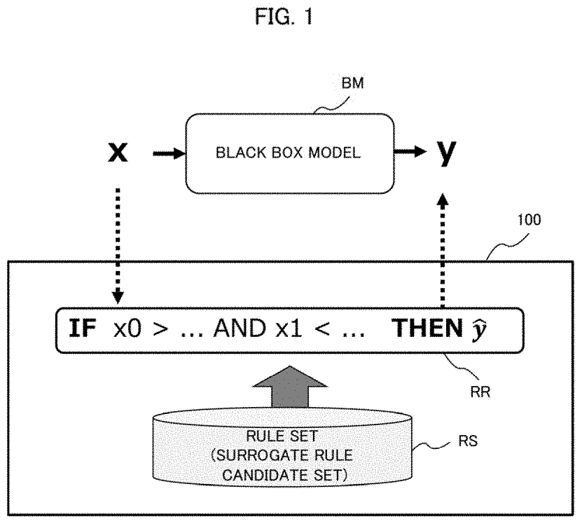

This example embodiment is characteristic in that reliability of a prediction result by a black box model can be confirmed by humans by explaining the processing by the black box model using rules prepared in advance. FIG. 1 is a diagram for conceptually explaining the technique of the present example embodiment. It is now assumed that there is a trained black box model BM. Although the black box model BM outputs the prediction result y for the input x, the reliability of the prediction result y is questionable because the contents of the black box model BM are unknown to humans.

Therefore, the information processing device 100 of this example embodiment prepares a rule set RS configured by simples rule that can be understood by humans in advance, and obtains a surrogate rule RR for the black box model BM from among the rule set RS. The surrogate rule RR is the rule which outputs the prediction result y\hat{ } closest to the black box model BM. That is, the surrogate rule RR is a highly interpretable rule that outputs the prediction result almost the same as the black box model BM. While humans cannot understand the contents of the black box model BM, they can rely on the prediction result of the black box model BM indirectly by understanding the contents of the surrogate rule RR which outputs almost the same prediction result as the black box model BM. Thus, it is possible to increase the reliability of the black box model BM.

Further, in the information processing device 100, as a further contrivance, the rules included in the rule set RS (hereinafter, also referred to as “surrogate rule candidates”) are selected in advance so that humans can confirm the rules. In other words, each of the surrogate rule candidates is a simple rule that humans can rely on. Thus, it is possible to prevent that the surrogate rules unreliable for humans are determined.

In order to obtain the above-mentioned effect, the following two conditions need to be satisfied for the rule set RS, i.e., the surrogate rule candidate set RS.
(Condition 1) For various inputs x, there always exists a rule that outputs the prediction result y\hat{ } which is almost the same as the prediction result y of the black box model BM.
(Condition 2) The size of the rule set RS, i.e., the number of the surrogate rule candidates is made as small as possible because the surrogate rule candidates are checked by humans.

The problem of determining the surrogate rule candidate set RS can be considered as an optimization problem of selecting, from the prepared plural rules, a surrogate rule candidate set in which the error between the prediction result y of the black box model BM and the prediction result y\hat{ } of the surrogate rule RR is made as small as possible and the number of the surrogate rule candidates is made as small as possible.

[Modeling]

Next, we concretely consider a model of the surrogate rule. The surrogate rule satisfies the following conditions:

“For the input x, when the black box model outputs the prediction result y, the rule in which the condition becomes true for the input x and the prediction result y\hat{ } becomes closest to the prediction result y is defined as a surrogate rule. At this time, the difference between the prediction results y and y\hat{ } is minimized while keeping the number of rules below a certain value.”

First, the black box model is shown by Equation (1.1), and training data D is shown by Equation (1.2).

y=f(x) (1.1)

D={(xᵢ,yᵢ)}ᵢ₌₁ⁿ (1.2)

The black box model f outputs the prediction result y for the input x. In addition, “i” in Equation (1.2) indicates the number of the training data, and it is assumed that there are n training data.

Next, the original rule set R₀ is given by Equation (1.3) and the rule is given by Equation (1.4).

R₀={rⱼ}ⱼ₌₁^{m} (1.3)

rⱼ=(cᵣ_{ⱼ},ŷᵣ_{ⱼ}) (1.4)
cᵣ_{ⱼ}: CONDITIONAL PART (IF)
ŷᵣ_{ⱼ}: PREDICTED VALUE WHEN CONDITION IS SATISFIED (THEN)
   Here, “j” indicates the rule number, and it is assumed that m rules are prepared. “cᵣⱼ” in Equation (1.4) is a conditional part and corresponds to IF of IF-THEN. “y\hat{ }ᵣⱼ” is the predicted value when the condition is satisfied, and corresponds to the part after THEN of IF-THEN rule. It is noted that the original rule set R₀ is a rule set arbitrarily prepared first, and a surrogate rule candidate set R is created from the original rule set R₀.

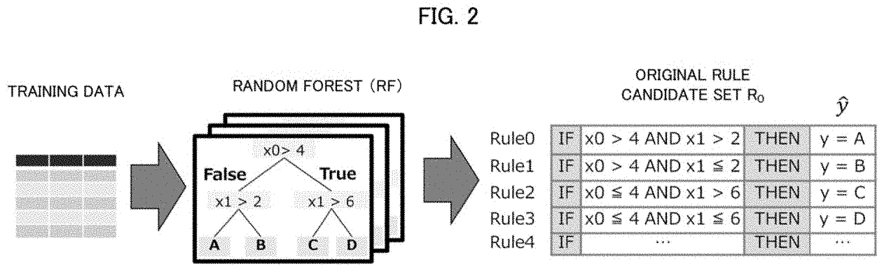

The method of creating the original rule set R₀ is not limited to any particular method, and the original rule set R₀ may be made manually, for example. Also, Random Forest (RF), which is a technique for generating a large amount of decision trees, may be used. FIG. 2 illustrates the creation of an original rule set R₀ using Random Forest. When Random Forest is used, a part of the decision tree from a root node to a leaf node may be regarded as one rule. The training data D is inputted to Random Forest, and the rules obtained can be used as the original rule set R₀. Also, in the case of a regression problem, the average value of the prediction results y of the examples fitting to the leaf nodes can be used as the prediction result y\hat{ }.

Next, we define a loss function that measures the error between the prediction result y of the black box model and the prediction result y\hat{ } of the surrogate rule. If the problem to be solved is a classification problem, the cross entropy can be used as the loss function. Also, when the problem to be solved is a regression problem, the following square error can be used as the loss function.

L(y,ŷ)=(y−ŷ)² (1.5)

In the following description, it is assumed that the square error is applied as the loss function for the regression problem. However, loss function is not limited to the square error.

Next, the objective function is defined. From the original rule set R₀, which is the initial rule set, we obtain the surrogate rule candidate set R⊂R₀, which is the subset of the original rule set R₀. Specifically, the surrogate rule candidate set R is expressed by the following equation.

$$R = arg {min}_{R ⊂ {R}_{0}} {\underbrace{{{\sum }^{n}}_{i = 1} L ( f ( {x}_{i} ) , {\hat{y}}_{{r}_{s u r} ( i )} )}}_{\begin{matrix}TOTAL SUM OF ERRORS \\ IN ALL TRAINING DATA\end{matrix}} + {\underbrace{{\sum }_{r ∈ R} {λ}_{r}}}_{\begin{matrix}TOTAL SUM OF COSTS λ r \\ CAUSED BY ADOPTING RULE r\end{matrix}} \qquad ( 1.6 )$$

As shown in Equation (1.6), the surrogate rule candidate set R is created to minimize the sum of the total sum of the errors in all training data and the total sum of the costs (hereinafter also referred to as “rule adoption cost”) λᵣ caused by adopting the rule r. By introducing the cost λᵣ, we can balance the error between the prediction results y and y\hat{ } with the number of candidate surrogate rules.

The surrogate rule is selected from the surrogate rule candidate set R as follows.

$${r}_{s u r} ( i ) = arg {min}_{r ∈ R , {x}_{i} satisfies {c}_{r}} L ( f ( {x}_{i} ) , {\hat{y}}_{r} ) \qquad ( 1.7 )$$

Here, the surrogate rule rₛᵤᵣ(i) is a rule in which the loss L between the prediction result y of the black box model and the prediction result y\hat{ } of the rule is minimized, among the rules included in the surrogate rule candidate set R and the input xᵢ satisfies the conditional cᵣ.

Next, a method of setting the rule adoption cost λᵣ shown in Equation (1.6) will be described. As described above, the rule adoption cost is introduced to balance the error between the prediction results y and y\hat{ } with the number of surrogate rule candidates. Therefore, by changing the rule adoption cost, it is possible to change the balance between the accuracy and explainability of the surrogate rule.

Specifically, when the rule adoption cost is high, the cost for adding the rule to the surrogate rule candidate set R becomes high, and therefore the surrogate rule candidate set R is optimized to have as few rules as possible. As a result, the explainability of the surrogate rule becomes high. On the other hand, when the rule adoption cost is low, the surrogate rule candidate set R includes more rules, and therefore the accuracy of the surrogate rule becomes high. Incidentally, if the rule adoption cost is too low, over-learning may occur due to the use of excessively complicated rules. However, by adjusting the rule adoption cost so that it does not become too high, the effect of preventing over-learning can be expected.

The rule adoption cost may be designated by a human and may be set mechanically by some methods. For example, the rule adoption cost may be changed in small increments to set a value at which the number of rules becomes 100 or less. Similarly, a data set for verification may be actually applied to a surrogate rule to measure the prediction accuracy of the surrogate rule, and the rule adoption cost may be adjusted so that the obtained prediction accuracy becomes an appropriate value.

The rule adoption cost may be a common value for all the rules, and a different value may be assigned to each individual rule. For example, the number of conditions used in the respective rules, i.e., the number of “AND” in the IF-THEN rule, may be considered. For example, a rule having a large number of conditions may be assigned a high value, and a rule having a small number of conditions may be assigned a low value. Thus, the surrogate rule candidate set R is optimized to use simple rules rather than complex rules as much as possible.

[Hardware Configuration]

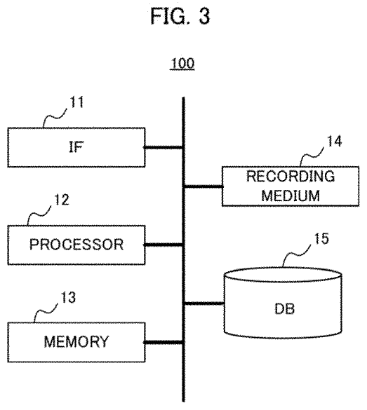

FIG. 3 is a block diagram illustrating a hardware configuration of an information processing device according to the first example embodiment. As shown, the information processing device 100 includes an interface (IF) 11, a processor 12, a memory 13, a recording medium 14, and a database (DB) 15.

The interface 11 communicates with external devices. Specifically, the interface 11 acquires observation data and prediction results of the black box model for the observation data. Also, the interface 11 outputs surrogate rule candidate sets, surrogate rules, prediction results by the surrogate rules, or the like obtained by the information processing device 100 to external devices.

The processor 12 is a computer such as a CPU (Central Processing Unit) and controls the entire information processing device 100 by executing a program prepared in advance. Note that the processor 112 may be a GPU (Graphics Processing Unit) or a FPGA (Field-Programmable Gate Array). Specifically, the processor 12 executes processing of generating a surrogate rule candidate set or processing of determining a surrogate rule using the inputted observation data and the prediction results of the black box model for the observation data.

The memory 13 may be configured by a ROM (Read Only Memory) and a RAM (Random Access Memory). The memory 13 stores various programs executed by the processor 12. The memory 13 is also used as a working memory during various processes performed by the processor 12.

The recording medium 14 is a non-volatile and non-transitory recording medium such as a disk-like recording medium or a semiconductor memory and is configured to be detachable from the information processing device 100. The recording medium 14 records various programs executed by the processor 12. When the information processing device 100 executes the training processing and the inference processing described later, the program recorded in the recording medium 14 is loaded into the memory 13 and executed by the processor 12.

The database 15 stores the observation data inputted to the information processing device 100 and the training data used in the training processing. The database 15 stores the above-described original rule set R₀, the surrogate rule candidate set R, and the like. In addition to the above, the information processing device 100 may include an input device such as a keyboard, a mouse, or a display device.

[Configuration at the Time of Training]

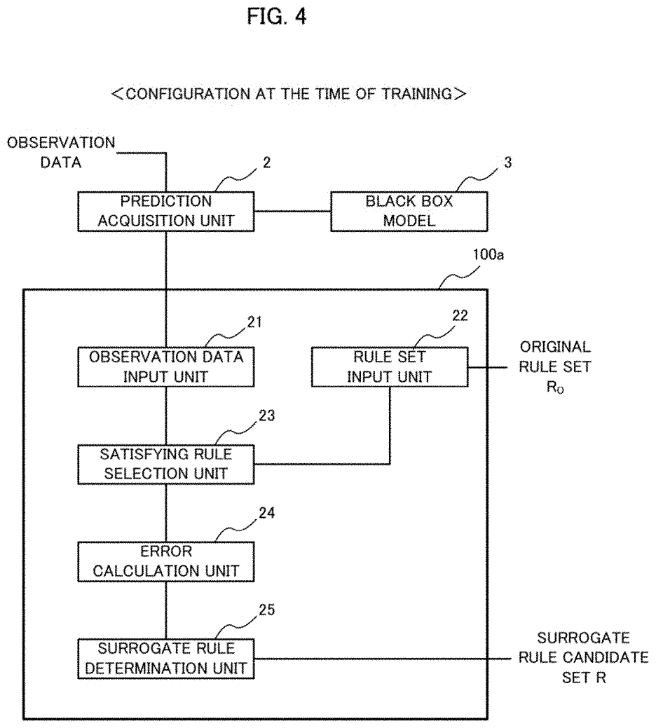

FIG. 4 is a block diagram illustrating a functional configuration of the information processing device at the time of training. The information processing device 100a at the time of training is used together with a prediction acquisition unit 2 and a black box model 3. The processing at the time of training is to generate a surrogate rule candidate set R for the black box model using the observation data and the black box model. The observation data at the time of training corresponds to the training data D described above. The information processing device 100a includes an observation data input unit 21, a rule set input unit 22, a satisfying rule selection unit 23, an error calculation unit 24, and a surrogate rule determination unit 25.

The prediction acquisition unit 2 acquires the observation data to be used for prediction by the black box model 3 and inputs the observation data to the black box model 3. The black box model 3 performs prediction for the inputted observation data, and outputs the prediction results to the prediction acquisition unit 2. The prediction acquisition unit 2 outputs the observation data and the prediction results by the black box model 3 to the observation data input unit 21 of the information processing device 100a.

The observation data input unit 21 receives the pair of the observation data and the prediction result for the observation data by the black box model 3, and outputs the pair to the satisfying rule selection unit 23. The rule set input unit 22 acquires the original rule set R₀ prepared in advance and outputs it to the satisfying rule selection unit 23.

From the original rule set R₀ acquired by the rule set input unit 22, the satisfying rule selection unit 23 selects the rule (hereinafter, referred to as the “satisfying rule”) for which the condition becomes true for the respective observation data and outputs the satisfying rules to the error calculation unit 24.

The error calculation unit 24 inputs the observation data to the respective satisfying rules and generates the prediction results by the satisfying rules. Then, the error calculation unit 24 calculates an error from the prediction result of the black box model 3 inputted in pairs with the observation data and the prediction result by the satisfying rule using the above-described loss function L, and outputs the error to the surrogate rule determination unit 25.

The surrogate rule determination unit 25 determines, for each observation data, a rule in which the sum of the total sum of the errors for the satisfying rules and the total sum of the rule adoption costs for the satisfying rules is minimum, as a surrogate rule candidate. Thus, the surrogate rule determination unit 25 determines the surrogate rule candidate for each observation data, and outputs the set of them as the surrogate rule candidate set R.

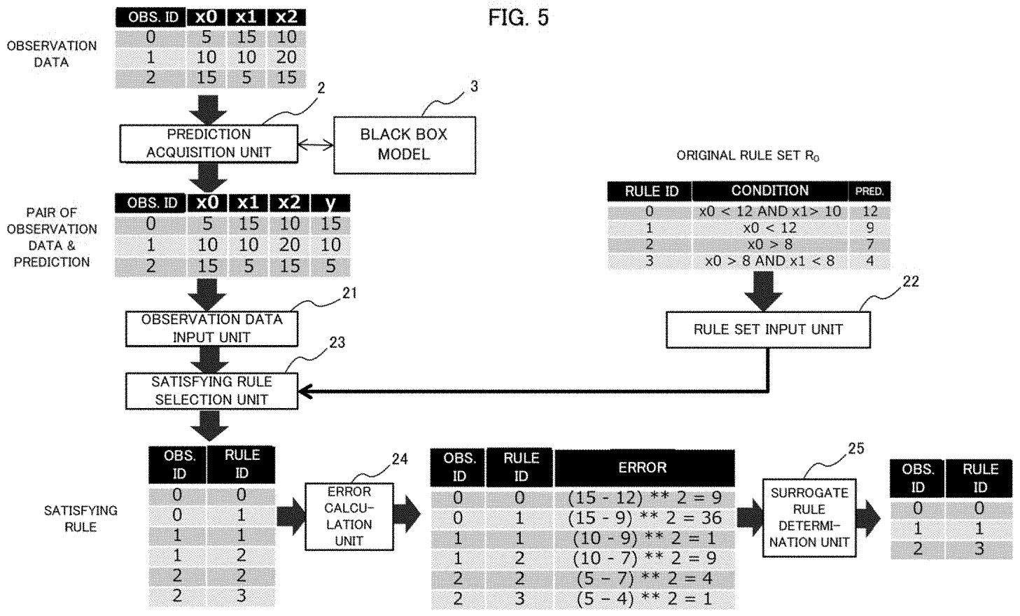

Next, processing at the time of training of the information processing device 100 will be described with reference to specific examples. FIG. 5 is a diagram showing an example of processing at the time of training of the information processing device 100. First, the observation data is inputted to the prediction acquisition unit 2. In this case, three observation data of the observation IDs “0” to “2” are inputted. Hereinafter, for convenience of explanation, the observation data having the observation ID “A” is referred to as “the observation data A”. Each observation data includes three values X0 to X2. The prediction acquisition unit 2 outputs the inputted observation data to the black box model 3. The black box model 3 performs prediction for three observation data, and outputs the prediction results y to the prediction acquisition unit 2.

The prediction acquisition unit 2 generates the pairs of the observation data and the prediction results y generated by the black box model 3 for the observation data. Then, the prediction acquisition unit 2 outputs the pairs of the observation data and the prediction results y to the observation data input unit 21. The observation data input unit 21 outputs the inputted pairs of the observation data and the prediction results y to the satisfying rule selection unit 23.

At the time of training, the original rule set R₀ is inputted to the rule set input unit 22. The rule set input unit 22 outputs the inputted original rule set R₀ to the satisfying rule selection unit 23. In this example, the original rule set R₀ includes four rules whose rule IDs are “0” to “3”. For convenience of explanation, a rule having the rule ID “B” is called “Rule B”.

From among the plurality of rules included in the original rule set R₀, the satisfying rule selection unit 23 selects the rule whose condition becomes true when the observation data is inputted, as the satisfying rule. For example, the observation data 0 includes X0=5, X1=15, X2=10, and the condition of rule 0 is “X0<12 AND X1>10”. Therefore, the observation data 0 satisfies the condition of the rule 0. That is, the condition of the rule 0 is true for the observation data 0. Therefore, the rule 0 is selected as the satisfying rule for observation data 0. In addition, the condition of the rule 1 is “x0<12,” and the condition of the rule 1 for the observation data 0 is true. Therefore, the rule 1 is selected as the satisfying rule for the observation data 0. On the other hand, the conditions of the rule 2 and rule 3 are not true for the observation data 0. Therefore, for the observation data 0, the rules 2 and 3 are not the satisfying rules.

Thus, for each observation data, the satisfying rule selection unit 23 selects the rule in which the condition becomes true, as the satisfying rule. As a result, in the example of FIG. 5, the rule 0 and the rule 1 are selected as the satisfying rules for the observation data 0, the rule 1 and the rule 2 are selected as the satisfying rules for the observation data 1, and the rule 2 and the rule 3 are selected as the satisfying rules for the observation data 2. Then, the satisfying rule selection unit 23 outputs the pairs of the observation data and the satisfying rule selected for the observation data to the error calculation unit 24.

The error calculation unit 24 calculates the error between the prediction result y of the black box model 3 and the prediction result by the satisfying rule for each pair of the inputted observation data and the satisfying rule. As the prediction result y of the black box model 3, the one inputted from the prediction acquisition unit 2 to the observation data input unit 21 is used. In addition, as the prediction result of the satisfying rule, the value prescribed in the original rule set R₀ is used. Here, it is assumed that the problem to be solved is a regression problem as described above, and the error calculation unit 24 calculates the error using the equation of the squared error shown in Equation (1.5). For example, for the observation data 0, since the prediction result y of the black box model is “15” and the prediction result by the rule 0 is “12”, the error L=(15−12)₂=9. Thus, the error calculation unit 24 calculates the error for each pair of the observation data and the satisfying rule, and outputs it to the surrogate rule determination unit 25.

The surrogate rule determination unit 25 generates the surrogate rule candidate set R based on the errors outputted by the error calculation unit 24 and the rule adoption costs when adopting each of the satisfying rules. Specifically, as shown in the previous Equation (1.6), the surrogate rule determination unit 25 determines the satisfying rule in which the sum of the total sum of the errors calculated by the error calculation unit 24 and the total sum of the rule adoption costs when adopting the respective satisfying rules is minimized, as the satisfying rule candidate for each observation data. Thus, the surrogate rule determination unit 25 determines the surrogate rule candidate for each observation data, and outputs the surrogate rule candidate set R which is a set of the surrogate rule candidates. The surrogate rule determination unit 25 determines the surrogate rule candidates by solving the optimization problem.

[Training Processing]

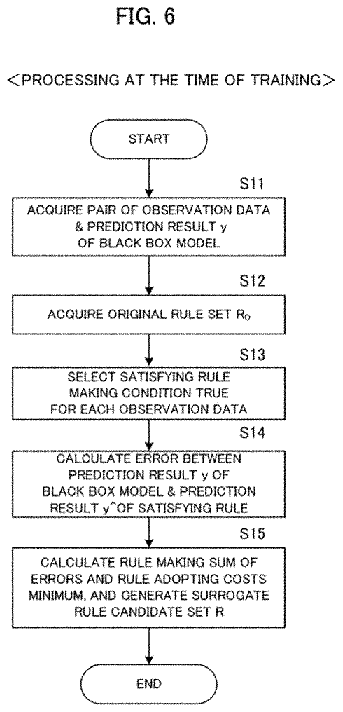

FIG. 6 is a flowchart of the training processing by the information processing device 100a. This processing is realized by the processor 12 shown in FIG. 3, which executes a program prepared in advance and operates as each element shown in FIG. 3.

First, as the pre-processing, the prediction acquisition unit 2 acquires the observation data that are the training data and inputs the observation data to the black box model 3. Then, the prediction acquisition unit 2 acquires the prediction results y by the black box model 3 and inputs the pairs of the observation data and the prediction result y to the information processing device 100a. Also, an original rule set R₀ including arbitrary rules is prepared in advance.

The observation data input unit 21 of the information processing device 100a acquires the pairs of the observation data and the prediction result y from the prediction acquisition unit 2 (step S11). Also, the rule set input unit 22 acquires the original rule set R₀ (step S12). Then, for each observation data, the satisfying rule selection unit 23 selects the rule whose condition is true as the satisfying rule, from among the rules included in the original rule set R₀ (step S13).

Next, the error calculation unit 24 calculates the error between the prediction result y of the black box model 3 and the prediction result y\hat{ } of the satisfying rule for each observation data (step S14). Then, the surrogate rule determination unit 25 determines the rule in which the sum of the total sum of the errors for the respective observation data calculated by the error calculation unit 24 and the total sum of the rule adoption costs for the satisfying rules for the respective each observation data is minimized, as the surrogate rule candidates for each observation data, and generates the surrogate rule candidate set R including those surrogate rules (step S15). Then, the processing ends.

In this way, at the time of training, the information processing device 100a generates a surrogate rule candidate set R that includes the surrogate rule candidate for each observation data using the observation data serving as the training data and the original rule set R₀ prepared in advance. This surrogate rule candidate set R is used as a rule set in actual operation.

In the training processing, the surrogate rule candidate set R is generated such that the total sum of the errors with the prediction results of the black box model and the total sum of the rule adoption costs become small for various training data. Therefore, since the rule which outputs almost the same prediction result as the black box model is selected as the surrogate rule candidate, it becomes possible to obtain a surrogate rule easily accepted as a surrogate explanation of the black box model. Moreover, since the surrogate rule candidate set R is generated so that the total sum of the rule adoption costs becomes small, the number of surrogate rule candidates is suppressed, making it easy for humans to check the reliability of surrogate rule candidates in advance.

[Configuration at the Time of Actual Operation]

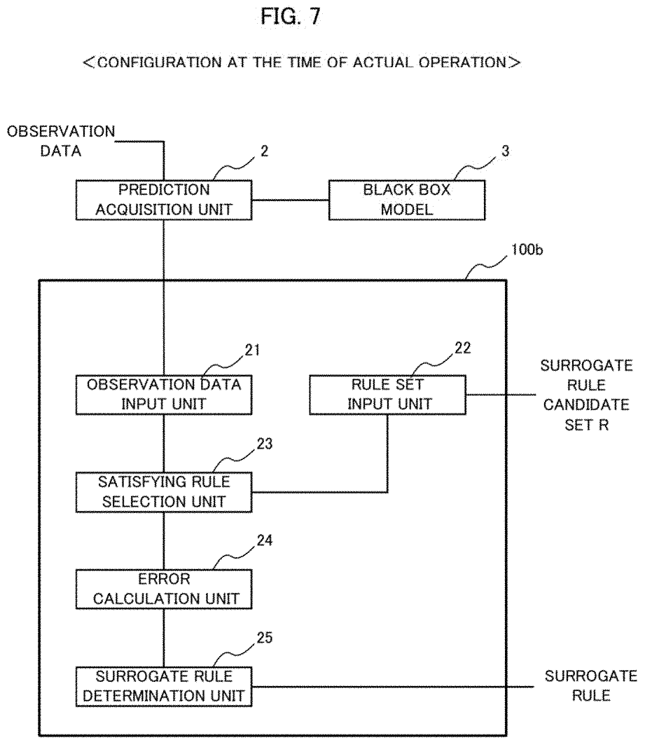

FIG. 7 is a block diagram illustrating a configuration of an information processing device according to the present example embodiment at the time of actual operation. The information processing device 100b at the time of actual operation basically has the same configuration as the information processing device 100a at the time of training shown in FIG. 4. However, at the time of actual operation, not the training data, but the observation data that is actually subjected to the prediction by the black box model 3 is inputted. Also, the surrogate rule candidate set R generated by the processing at the time of training is inputted to the rule set input unit 22.

At the time of actual operation, for the inputted observation data, a plurality of satisfying rules are selected from the surrogate rule candidates included in the surrogate rule candidate set R, and the error between the prediction result y by the black box model 3 and the prediction result y\hat{ } by the satisfying rule is calculated. Then, the satisfying rule having the minimum error is outputted as the surrogate rule.

[Processing at the Time of Actual Operation]

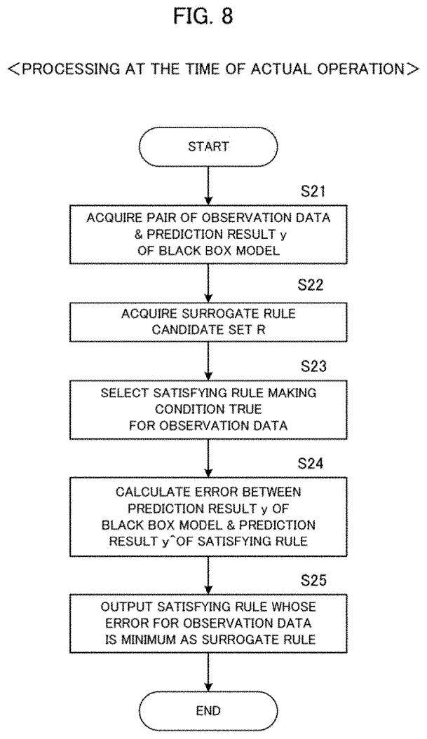

FIG. 8 is a flowchart of processing at the time of actual operation by the information processing device 100b. This processing is realized by the processor 12 shown in FIG. 3, which executes a program prepared in advance and operates as each element shown in FIG. 7.

First, as pre-processing, the prediction acquisition unit 2 acquires the observation data subjected to prediction and inputs it to the black box model 3. Then, the prediction acquisition unit 2 acquires the prediction result y by the black box model 3 and inputs the pair of the observation data and the prediction result y to the information processing device 100b. Also, the surrogate rule candidate set R generated by the above-described training processing is inputted to the information processing device 100b.

The observation data input unit 21 of the information processing device 100b acquires the pair of the observation data and the prediction result y from the prediction acquisition unit 2 (step S21). Also, the rule set input unit 22 acquires the surrogate rule candidate set R (step S22). Then, the satisfying rule selection unit 23 selects, as the satisfying rule, the rule whose condition becomes true for the observation data, from among the rules included in the surrogate rule candidate set R (step S23).

Next, the error calculation unit 24 calculates the error between the prediction result y of the black box model 3 and the prediction result y\hat{ } of the satisfying rule for the observation data (step S24). Then, the surrogate rule determination unit 25 determines and outputs the rule, in which the error calculated by the error calculation unit 24 is minimum, as the surrogate rule for the observation data, from among the satisfying rules (step S25). Then, the processing ends.

Thus, at the time of actual operation, the information processing device 100b determines the surrogate rule for the observation data by using the surrogate rule candidate set R obtained by the training performed in advance. Since this surrogate rule is a rule which outputs almost the same prediction result as the black box model for the observation data, this surrogate rule can be used for the surrogate explanation of the prediction by the black box model. This can improve the interpretability and reliability of the black box model.

[Effect by the Present Example Embodiment]

As described above, in the present example embodiment, since the surrogate rule which minimizes the error with the prediction result of the black box model is outputted at the time of actual operation, the surrogate rule becomes easy for humans to accept as an explanation of the prediction by the black box model. In the actual operation, the prediction result y\hat{ } by the obtained surrogate rule may be adopted instead of the prediction result y by the black box model. This is because, while the prediction by the black box model cannot show the grounds, the prediction by the surrogate rule can show its condition part as the grounds, and it is more interpretable and acceptable by humans.

Further, in the present example embodiment, since the surrogate rule candidate set R used for the determination of the surrogate rule has been generated in advance, and a human can check the surrogate rule candidate set R in advance. Therefore, it is possible to grasp in advance what kind of prediction is outputted during the actual operation. In other words, since the prediction using rules not included in the surrogate rule candidate set R is never outputted, the prediction by the surrogate rule can be used at ease.

[Optimization Processing by Surrogate Rule Determination Unit]

Next, the optimization processing by the surrogate rule determination unit will be described. As described above, at the time of training by the information processing device 100a, the surrogate rule determination section 25 generates the surrogate rule candidate set R by solving the optimization problem. Specifically, for each observation data serving as the training data, the surrogate rule determination unit 25 determines the surrogate rule candidate from the original rule set R₀ such that the sum of the total sum of the errors between the prediction result y by the black box model 3 and the prediction results y\hat{ } by the satisfying rules and the total sum of the rule adoption costs λᵣ for the satisfying rules is minimized. This can be regarded as a problem of assignment which assigns rules to observation data. First, a simple example is given to illustrate how to determine the surrogate rule candidates.

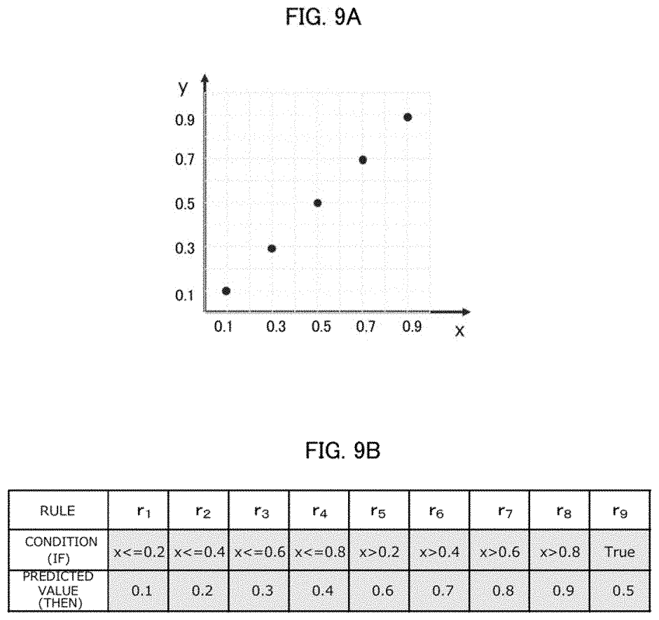

It is assumed that the black box model is y=x and five data (0.1, 0.3, 0.5, 0.7, and 0.9) are given as the observation data x. In this case, the predicted values y of the black box model for the observation data x are shown in FIG. 9A.

Also, it is assumed that the nine rules r₁ to r₉ shown in FIG. 9B are given as the original rule set R₀ for the five observation data. Incidentally, the rules r₁ to r₈ have the large/small determination using one of “0.2,” “0.4,” “0.6,” “0.8” as a threshold value, as the condition (IF). However, the rule r₉ is a default rule that fits to everything without any conditions. By providing a default rule, it is possible to prevent that there exists an observation data to which no rule fits. The predicted values (THEN) of the rules r₁ to r₉ are the averages of the observation data x that fits the rules.

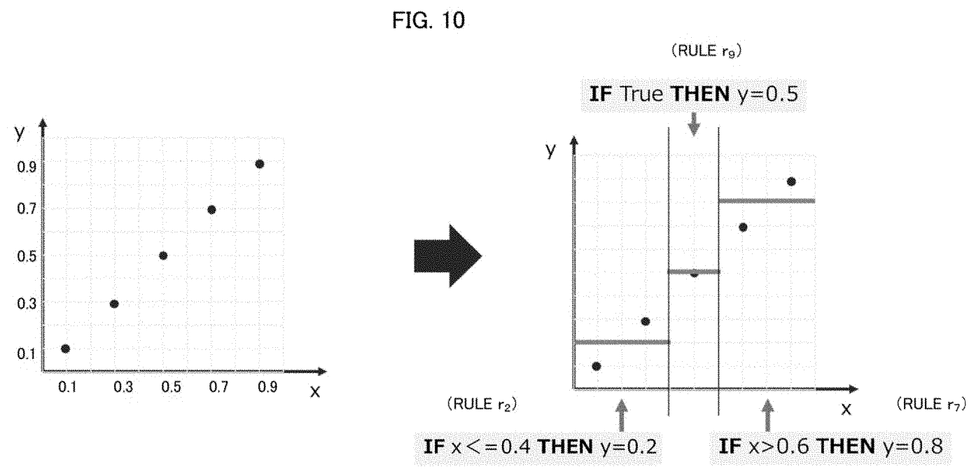

First, for clarity, the size of the surrogate rule candidate set R, i.e., the number of surrogate rule candidates, is temporarily fixed to “3”. That is, from among the nine rules r₁ to r₉, we consider a combination in which the sum of the errors and the rule adoption costs is minimized, from among the three rules. However, one of the three rules is the default rule r₉, and the average “0.5” of the five observation data is always predicted. In this case, as shown in FIG. 10, r₂, r₇, r₉ are the set of the surrogate rule candidates that minimizes the sum of the total sum of the errors of the prediction results and the total sum of the rule adoption costs.

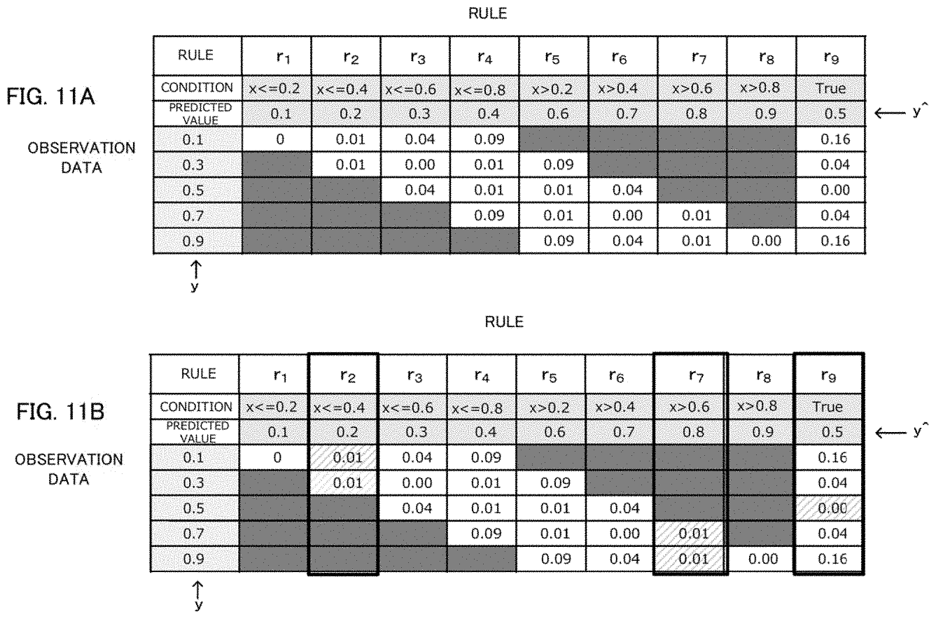

This is expressed using an error matrix. FIG. 11A shows an error matrix for r₁ to r₉. The column of the predicted values shows the prediction results y of the black box model for the five observation data, and the row of the predicted values shows the prediction results y\hat{ } by each rule r₁ to r₉. Out of the cells in the matrix, the gray cells indicate the case where the observation data does not satisfy the condition (IF) of the rule r. In that case, the error is not calculated. On the other hand, the white cells indicate the square error calculated using the prediction result y of the black box model and the prediction result y\hat{ } by each rule.

When three rules are selected so that the sum of the total sum of the errors and the total sum of the rule adoption costs is minimized based on the error matrix of FIG. 11A, the rules r₂, r₇, r₉ are selected as shown in FIG. 11B. Thus, when the surrogate rule candidate set R is selected, the assignment of each observation data and the surrogate rule is determined at the same time.

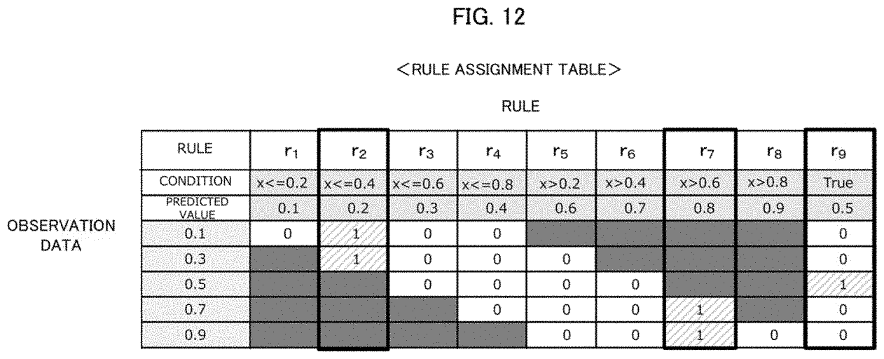

FIG. 12 is an assignment table of the surrogate rules for each observation data. The cell to which each rule is assigned is filled in with “1”. In this case, among the three rules, the rule r₂ is assigned to the observation data “0.1” and “0.3”, the rule r₉ is assigned to the observation data “0.5”, and the rule r₇ is assigned to the observation data “0.7” and “0.9”.

[Solving Optimization Problem]

As a method of solving the assignment problem as described above, at least two methods are considered: a method for solving as a discrete optimization, and a method for solving by approximating to continuous optimization. Both will be described below in order.

(Discrete Optimization)

A description will be given of an example of solving the problem of assigning the surrogate rule candidate to the observation data as an optimization problem. In the following example, the above assignment problem is transformed into a problem called weighted maximum satisfiability assignment problem (Weighted MaxSAT) and solved as a discrete optimization problem.

(1) Premise

(1.1) Satisfiability Problem

A satisfiability problem (SAT) is a decision problem that asks whether a boolean (True,False) assignment exists for every logical variable that satisfies a given logical expression (YES/NO). The logical expression given here is given by the conjunctive normal form (CNF). The conjunctive normal form is expressed in the form of ∧ᵢ∨ⱼx_{i,j} for a logical variable or a negation x_{i,j} of a logical variable, and the disjunction part (∨ⱼx_{i,j}) is called a clause. For example, when a CNF logical expression (A∨¬B)(¬A∨B∨C) is given, assigning the boolean values A=True, B=False, C=True to the logical variables satisfies the given logical expression, so it becomes YES.

Next, the maximum satisfiable assignment problem (MaxSAT) is a problem of finding an assignment of boolean values for a given CNF logical expression such that the number of satisfied clauses becomes maximum. In addition, the weighted maximum satisfiable assignment problem (Weighted MaxSAT) is a problem in which CNF logical expressions with weights added to each clause are given, and which obtains the boolean value assignment such that the sum of the weights of the satisfied clauses becomes maximum. This is equivalent to the problem of minimizing the sum of the weights of clauses that are not satisfied. In particular, the clauses with finite weights are called Soft clauses, and the clauses with infinite (=∞) weights are called Hard clauses, and Hard clauses must be satisfied.

(2) Model Based on Surrogate Rules

(2.1) Summary of Proposed Model

The original rule set is given as R₀={rⱼ}^{m}ⱼ₌₁. An arbitrary rule rⱼ is represented by a tuple (cᵣⱼ, y\hat{ }ᵣⱼ) of the condition cᵣⱼ and the result y\hat{ }ᵣⱼ. For a certain input data x∈X, the rule rⱼ outputs y\hat{ }ᵣⱼ when x satisfies the condition cᵣⱼ.

Proposed model: f_{rule_s}

Outputs the following surrogate rule rₛᵤᵣ=f_{rule_s} (x,R,f) for the input data x, the original rule set R₀={rⱼ}^{m}ⱼ₌₁ and an arbitrary black box model f:X→Y.

$$\begin{matrix}{r}_{sur} & = & {f}_{rule\_s} ( x , R , f ) & ( 2.1 ) \\ & = & arg {min}_{r ∈ R , x satisfies {c}_{r}} ( L ( f ( x ) , {\hat{y}}_{r} ) ) & ( 2.2 )\end{matrix}$$

Here, L(y,y′) is any loss-function that measures the error between y and y′. For the regression problem, the following square error is given as a loss function.

L( [symbol] , [symbol] )=( [symbol] − [symbol] )² (2.3)

This proposed model can realize both the explainability by the rule and the high prediction accuracy by determining the rule closest to the predicted value of any black box model of high accuracy to be a surrogate rule and outputting the surrogate rule as the prediction result. On the other hand, it does not have the interpretability of why the rule was selected. Therefore, the original rule set R₀ created in advance needs to be checked manually by humans in advance to increase the reliability of the rules. When the number of the rules |R₀| is small, confirming the rules by humans is easy, but the prediction accuracy is lowered. When the number of rules is large, the prediction accuracy becomes high, but the cost for examining the rules increases. Thus, the prediction error and the number of rules are in the trade-off relation. Therefore, when the training data D={(xᵢ, yᵢ)}ⁿᵢ₌₁ and the large original rule set R₀ are given as the inputs, the appropriate surrogate rule candidate set R is obtained.

(Problem)

Input: Training data D={(xᵢ, yᵢ)}ⁿᵢ₌₁, an original rule set R₀, a rule adoption cost ∧={λᵣ}_{r∈R}

Output: Surrogate rule candidate set R satisfying:

$$R = arg {min}_{R ⊂ {R}_{0}} {{\sum }^{n}}_{i = 1} L ( f ( {x}_{i} ) , {\hat{y}}_{{r}_{s u r} ( i )} ) + {\sum }_{r ∈ R} {λ}_{r} \qquad ( 2.4 )$$

$${r}_{sur} ( i ) = {f}_{rule\_s} ( {x}_{i} , R , f ) \qquad ( 2.5 )$$

By varying the value of the rule adoption cost λᵣ, it is possible to adjust the balance between the prediction error and the number of rules.

(2.2) Optimizing Rule Set by Weighted Max Horn SAT

In order to optimize the surrogate rule candidate set R, we propose a method for transforming Equation (2.4) to a weighted MaxSAT. First, we introduce two types of logical variables oⱼ and e_{i,j}. Here, for all 1≤j≤|R₀|, a logical variable oⱼ corresponding to the rule rⱼ is generated, and the set of the logical variables is given by O. Also, for all 1≤i≤n and 1≤j≤|R₀|, a logical variable e_{i,j} corresponding to only the case where the training data xᵢ satisfies the conditional cⱼ of the rule rⱼ is generated, and the set of these logical variables is given by E. The boolean values are assigned to these logical variables under the following conditions:
oⱼ=True if the outputted surrogate rule candidate set R includes the rule rⱼ
e_{i,j}=True if the surrogate rule for the data xᵢ is rⱼ

(Hard Clauses)

For the logical variables oⱼ and e_{i,j} given above, logical expressions representing the following two constraints are given.

$${∧}_{{o}_{j} ∈ 𝒪 , {ε}_{i , j} ∈ ℰ} ( {e}_{i , j} ⟹ {o}_{j} ) \qquad ( 2.6 )$$

$${∧}_{k = 1 , … , n} {∨}_{{e}_{k , j} ∈ ℰ} {e}_{k , j} \qquad ( 2.7 )$$

The logical expression (2.6) indicates that, if rⱼ is adopted as the surrogate rule for each training data xᵢ, rⱼ should be included in the surrogate rule candidate set R to be outputted. Also, the logical expression (2.7) indicates that there is always a surrogate rule for each training data xᵢ.

(Soft Clauses)

As shown in Equation (2.4), the optimization of the surrogate rule candidate set R is performed by minimizing the sum of the total sum

Σᵢ₌₁ⁿL(f(xᵢ), [symbol] ₍ᵢ₎)

of the errors between the prediction value of the black box model and the prediction value of the surrogate rule and the total sum of the rule adoption costs

Σ_{r∈R}λᵣ

for a given training data. By encoding to MaxSAT, when oⱼ is True, the rule adoption cost λⱼ is paid. Also, when e_{i,j} is True (i.e., rⱼ=rₛᵤᵣ(i)), the error L(f(xᵢ), y\hat{ }ᵣⱼ) between the predicted value of the black box model and the predicted value of the surrogate rule is paid as the cost. Therefore, the following logical expression which takes the logical negations (¬) of them is given as the soft clauses.

$${∧}_{{a}_{j} ∈ 𝒪} ( - {o}_{j} ) ∧ {∧}_{{e}_{i} , j ∈ ℰ} ( - {e}_{i , j} ) \qquad ( 2.8 )$$

Here, the weights assigned to each clause are given by

w(¬oⱼ)=λᵣ_{ⱼ},w(¬e_{i,j})=L(f(xᵢ), [symbol] ᵣ_{ⱼ}) (2.9)

As mentioned in the above item (1.1), the boolean value is assigned to the logical variable so that the sum of the weights of the clauses that do not satisfy is minimized. When the rule rⱼ is included in the surrogate rule candidate set that is outputted as the optimal solution, ¬oⱼ becomes False, and therefore λᵣⱼ is paid as the cost.

(Example)

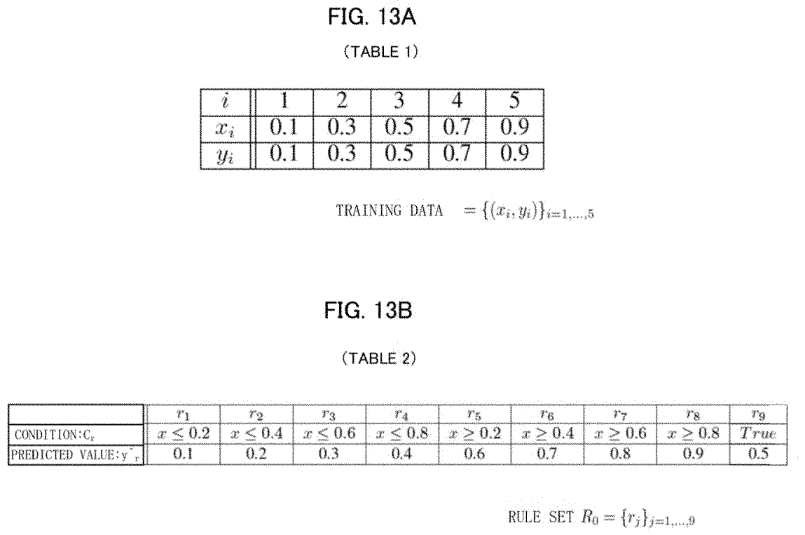

As an example, we consider the training data shown in Table 1 of FIG. 13A and the rule set shown in Table 2 of FIG. 13B. Also, we give y=x as the black box model f(x) and give the same rule adoption cost λᵣⱼ=0.5 for all the rules rⱼ.

First, the logical variables introduced to this example will be described. For oᵢ, nine logical variables o₁, . . . , o₉ are generated. For e_{i,j}, the logical variable is generated only when xᵢ satisfies the condition of rⱼ. For example, since the training data x₁=0.1 satisfies the condition x≤0.4 of the rule r₂, the logical variable e_{1,2} is generated. However, since the training data x₃=0.5 does not satisfy the condition of the rule r₂, the logical variable e_{3,2} is not generated.

From Equation (2.8), as the Soft clauses, ¬o₁∧ . . . ∧¬o₉∧¬e_{1,1}∧¬e_{1,2}∧ . . . ∧¬e_{5,9} are given. Here, from Equation (2.9), the weights w (oⱼ)=λᵣⱼ=0.5) are assigned to each ¬oⱼ. In addition, since L(f(xᵢ), y\hat{ }ⱼ) is assigned to each ¬e_{i,j}, when the error function L is the square error, a weight w (e_{1,2})=L(f(x₁), y\hat{ }₂)=(0.1−0.4)²=0.09 is assigned to e_{1,2}, for example.

Next, the hard clauses corresponding to Equation (2.6) are given as follows:

(e_{1,1}⇒o₁)∧(e_{1,2}⇒o₂)∧ . . . ∧(e_{5,9}⇒o₉)

For example, (e_{1,2}⇒o₂) indicates that, when the surrogate rule explaining the training data x₁ is r₂, the rule r₂ must be included in the surrogate rule candidate set to be outputted.

Finally, the hard clauses corresponding to Equation (2.7) are given as follows:

(e_{1,1}∨e_{1,2}∨e_{1,3}∨e_{1,4}∨e_{1,9})∧ . . . ∧(e_{5,5}∨e_{5,6}∨e_{5,7}∨e_{5,8}∨e_{5,9})

For example, the first clause (e_{1,1}∧e_{1,2}∨e_{1,3}∨e_{1,4}∨e_{1,9}) ensures that there is a surrogate rule that explains the training data x₁.

By inputting these logical expressions into MaxSAT solver, the solver returns the assignment of the boolean (True/False) values for all the logical variables oⱼ, e_{i,j}. Here, any MaxSAT solver can be used. For example, openwbo and MaxHS are typical examples.

Specifically, we focus on oⱼ serving as a return value from the solver. If the values returned in the order of: o₁=True, o₂=False, o₃=False, o₄=False, o₅=True, o₆=False, o₇=False, o₈=True, o₉=True, the rules r₁, r₅, r₈, r₉ are outputted as the surrogate rule candidate set R as a result of optimizing the rule set.

(Solution by Continuous Optimization)

In the above solution by the discrete optimization method, the assignment of whether or not to use a certain rule for a certain example is determined by “0” or “1”. On the other hand, in the solution by continuous optimization, instead of discretely determining the assignment by “0” or “1”, the assignment is continuously optimized by regarding it as a continuous variable in the range of “0” to “1”. Thus, the technique of continuous optimization can be applied.

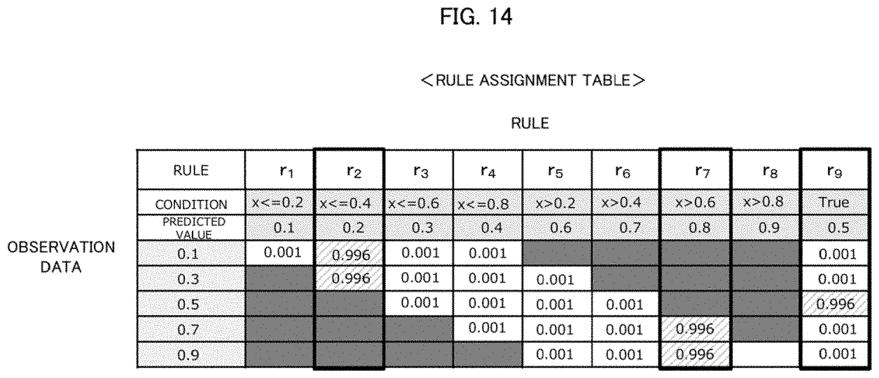

FIG. 14 shows an example of a table of assignment determined by the continuous optimization. Incidentally, the case is the same as the case of the discrete optimization, and FIG. 14 is an assignment table corresponding to FIG. 12 in the case of the discrete optimization. As will be appreciated by comparison with FIG. 12, the assignment of rules for each example is shown by a continuous value. The sum of the assigned values in each row is “1”.

Thus, after calculating the values indicating the assignment by the method of the continuous optimization, for example, by forcibly converting the value close to “0” to “0” and the value close to “1” to “1” with using a threshold value “0.5”, the final assignment between the examples and the rules can be obtained.

### Third Example Embodiment

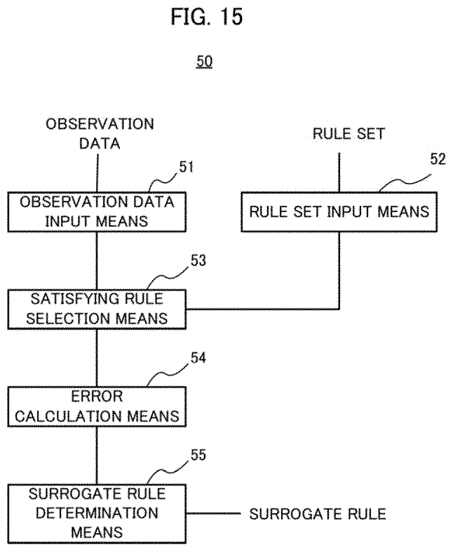

FIG. 15 is a block diagram illustrating a functional configuration of an information processing device according to a third example embodiment. The information processing device 50 includes an observation data input means 51, a rule set input means 52, a satisfying rule selection means 53, an error calculation means 54, and a surrogate rule determination means 55. The observation data input means 51 receives a pair of observation data and a predicted value of a target model for the observation data. The rule set input means 52 receive a rule set including a plurality of rules, the rule including a pair of a condition and a predicted value corresponding to the condition. The satisfying rule selection means 53 selects a satisfying rule from the rule set, the satisfying rule being a rule in which the condition becomes true for the observation data. The error calculation means 54 calculates an error between a predicted value of the satisfying rule for the observation data and the predicted value of the target model. The surrogate rule determination means 55 associates the rule which minimizes the error, among the satisfying rules, with the observation data as a surrogate rule for the target model.

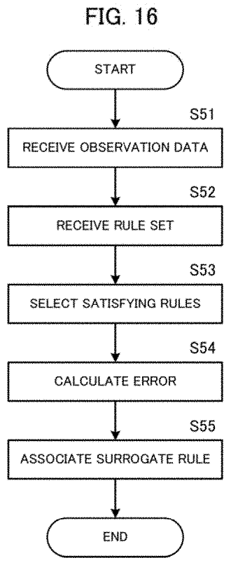

FIG. 16 is a flowchart illustrating processing performed by the information processing device according to the third example embodiment. First, the observation data input means 51 receives a pair of observation data and a predicted value of a target model for the observation data (step S51). Also, the rule set input means 52 receive a rule set including a plurality of rules, the rule including a pair of a condition and a predicted value corresponding to the condition (step S52). Incidentally, the order of steps S51 and S52 may be reversed, and they may be executed in parallel. The satisfying rule selection means 53 selects a satisfying rule from the rule set, the satisfying rule being a rule in which the condition becomes true for the observation data (step S53). The error calculation means 54 calculates an error between a predicted value of the satisfying rule for the observation data and the predicted value of the target model (step S54). Then, the surrogate rule determination means 55 associates the rule which minimizes the error, among the satisfying rules, with the observation data as a surrogate rule for the target model (step S55).

According to the information processing device of the third example embodiment, among the rules satisfying the condition for the observation data, the rules that output the predicted value closest to the predicted value of the target model is determined as the surrogate rule. Therefore, the surrogate rule can be used for the explanation of the target model.

A part or all of the example embodiments described above may also be described as the following supplementary notes, but not limited thereto.

(Supplementary Note 1)

An information processing device comprising:
an observation data input means configured to receive a pair of observation data and a predicted value of a target model for the observation data;
a rule set input means configured to receive a rule set including a plurality of rules, the rule including a pair of a condition and a predicted value corresponding to the condition;
a satisfying rule selection means configured to select a satisfying rule from the rule set, the satisfying rule being a rule in which the condition becomes true for the observation data;
an error calculation means configured to calculate an error between a predicted value of the satisfying rule for the observation data and the predicted value of the target model; and
a surrogate rule determination means configured to associate the rule which minimizes the error, among the satisfying rules, with the observation data as a surrogate rule for the target model.

(Supplementary Note 2)

The information processing device according to claim 1,
wherein the rule set input means receives, as the rule set, a surrogate rule candidate set prepared in advance, and
wherein the surrogate rule determination means outputs the surrogate rule associated with the observation data.

(Supplementary Note 3)

The information processing device according to claim 1 or 2, wherein the surrogate rule determination means outputs a predicted value of the surrogate rule and the predicted value of the target model.

(Supplementary Note 4)

The information processing device according to claim 1,
wherein the observation data input means receives a plurality of pairs of the observation data and the predicted values of the target model, and
wherein the surrogate rule determination means outputs a plurality of surrogate rules associated with the plurality of observation data as a surrogate rule candidate set.

(Supplementary Note 5)

The information processing device according to claim 4, wherein the surrogate rule determination means determines the satisfying rule in which a sum of a total sum of costs in case of adopting the satisfying rule and a total sum of the errors for the plurality of observation data is minimized, as the surrogate rule.

(Supplementary Note 6)

The information processing device according to claim 5, wherein the surrogate rule determination means determines the surrogate rule by solving an optimization problem of assigning the rules such that the sum becomes minimum for the observation data.

(Supplementary Note 7)

The information processing device according to claim 5 or 6,
wherein the rule set input means receives an original rule set prepared in advance, and
wherein the cost is determined in advance for each rule belonging to the original rule set.

(Supplementary Note 8)

An information processing method comprising:
receiving a pair of observation data and a predicted value of a target model for the observation data;
receiving a rule set including a plurality of rules, the rule including a pair of a condition and a predicted value corresponding to the condition;
selecting a satisfying rule from the rule set, the satisfying rule being a rule in which the condition becomes true for the observation data;
calculating an error between a predicted value of the satisfying rule for the observation data and the predicted value of the target model; and
associating the rule which minimizes the error, among the satisfying rules, with the observation data as a surrogate rule for the target model.

(Supplementary Note 9)

A recording medium recording a program, the program causing a computer to execute an information processing method comprising:
receiving a pair of observation data and a predicted value of a target model for the observation data;
receiving a rule set including a plurality of rules, the rule including a pair of a condition and a predicted value corresponding to the condition;
selecting a satisfying rule from the rule set, the satisfying rule being a rule in which the condition becomes true for the observation data;
calculating an error between a predicted value of the satisfying rule for the observation data and the predicted value of the target model; and
associating the rule which minimizes the error, among the satisfying rules, with the observation data as a surrogate rule for the target model.

While the present invention has been described with reference to the example embodiments and examples, the present invention is not limited to the above example embodiments and examples. Various changes which can be understood by those skilled in the art within the scope of the present invention can be made in the configuration and details of the present invention.

### DESCRIPTION OF SYMBOLS

2 Prediction acquisition unit
3, BM Black box model
21 Observation data input unit
22 Rule set input unit
23 Satisfying rule selection unit
24 Error calculation unit
25 Surrogate rule determination unit
100, 100a, 100b Information processing device
RR Surrogate rule
RS Rule set

What is claimed is:

1. An information processing device comprising:
a memory configured to store instructions; and
one or more processors configured to execute the instructions to:
receive a pair of observation data and a predicted value of a target model for the observation data;
receive a rule set including a plurality of rules, the rule including a pair of a condition and a predicted value corresponding to the condition;
select a satisfying rule from the rule set, the satisfying rule being a rule in which the condition becomes true for the observation data;
calculate an error between a predicted value of the satisfying rule for the observation data and the predicted value of the target model; and
associate the rule which minimizes the error, among the satisfying rules, with the observation data as a surrogate rule for the target model.

2. The information processing device according to claim 1,
wherein the one or more processors receive, as the rule set, a surrogate rule candidate set prepared in advance, and
wherein the one or more processors output the surrogate rule associated with the observation data.

3. The information processing device according to claim 1, wherein the one or more processors output a predicted value of the surrogate rule and the predicted value of the target model.

4. The information processing device according to claim 1,
wherein the one or more processors receive a plurality of pairs of the observation data and the predicted values of the target model, and
wherein the one or more processors output a plurality of surrogate rules associated with the plurality of observation data as a surrogate rule candidate set.

5. The information processing device according to claim 4, wherein the one or more processors determine the satisfying rule in which a sum of a total sum of costs in case of adopting the satisfying rule and a total sum of the errors for the plurality of observation data is minimized, as the surrogate rule.

6. The information processing device according to claim 5, wherein the one or more processors determine the surrogate rule by solving an optimization problem of assigning the rules such that the sum becomes minimum for the observation data.

7. The information processing device according to claim 5,
wherein the one or more processors receive an original rule set prepared in advance, and
wherein the cost is determined in advance for each rule belonging to the original rule set.

8. An information processing method comprising:
receiving a pair of observation data and a predicted value of a target model for the observation data;
receiving a rule set including a plurality of rules, the rule including a pair of a condition and a predicted value corresponding to the condition;
selecting a satisfying rule from the rule set, the satisfying rule being a rule in which the condition becomes true for the observation data;
calculating an error between a predicted value of the satisfying rule for the observation data and the predicted value of the target model; and
associating the rule which minimizes the error, among the satisfying rules, with the observation data as a surrogate rule for the target model.

9. A non-transitory computer-readable recording medium recording a program, the program causing a computer to execute an information processing method comprising:
receiving a pair of observation data and a predicted value of a target model for the observation data;
receiving a rule set including a plurality of rules, the rule including a pair of a condition and a predicted value corresponding to the condition;
selecting a satisfying rule from the rule set, the satisfying rule being a rule in which the condition becomes true for the observation data;
calculating an error between a predicted value of the satisfying rule for the observation data and the predicted value of the target model; and
associating the rule which minimizes the error, among the satisfying rules, with the observation data as a surrogate rule for the target model.
